(19) United States
(12) Patent Application Publication
(10) Pub. No.: US 2012/0185312 A1
(43) Pub. Date: Jul. 19, 2012

(54) SYSTEMS AND METHODS FOR IMPLEMENTING FINANCIAL TRANSACTIONS

(75) Inventors: Robert Nix, Concord, MA (US); Peter Masters, Arlingon, MA (US); Jeffrey Schachter, Littleton, MA (US); Theodore Schwartz, Stow, MA (US); Ben Lee, Hudson, MA (US)

(73) Assignee: Heartland Payment Systems, Inc., Princeton, NJ (US)

(21) Appl. No.: 13/271,072

(22) Filed: Oct. 11, 2011

Related U.S. Application Data
(63) Continuation of application No. 12/691,330, filed on Jan. 21, 2010, now abandoned.
Application No. 12/691,330 is a continuation of application No. 11/739,012, filed on Apr. 23, 2007, now abandoned.
(60) Provisional application No. 60/794,417, filed on Apr. 24, 2006.

(51) Int. Cl. G06Q 20/20; G06Q 20/38; G06Q 30/02

(52) U.S. Cl. 705/14.17; 705/16; 705/39

(57) ABSTRACT

A payment processing system to provide merchant-specific accounts to consumers that are accessed by payment instruments. In one embodiment, the payment processing system can create and provide a variety of payment methodologies for purchases, such as pay-as-you-go, virtual prepaid, virtual subscription, and post-paid purchases. The merchant may, in some embodiments provide consumers with merchant rewards accounts and an opportunity to earn reward points or other loyalty-based currencies through qualifying purchase transactions. The consumer may access their merchant-specific accounts for purchase payment using a preferred payment instrument, such as a credit or debit card.

### CROSS-REFERENCE TO APPLICATION(S) INCORPORATED BY REFERENCE

The present application claims priority to U.S. Provisional Patent Application No. 60/794,417, filed Apr. 24, 2006, entitled “SMALL TRANSACTION SUITE,” and incorporated herein in its entirety by reference. The present application incorporates the subject matter of U.S. patent application Ser. No. 11/169,075, entitled “PAYMENT PROCESSING METHOD AND SYSTEM,” filed Jun. 27, 2005, in its entirety by reference. The present application also incorporates the subject matter of U.S. patent application Ser. No. 10/553,611, entitled “MICROPAYMENT PROCESSING METHOD AND SYSTEM,” filed Oct. 18, 2005, in its entirety by reference.

### TECHNICAL FIELD

The present invention relates generally to payment processing and, more specifically, to processing financial transactions with one or more accounts linked to a payment instrument.

### BACKGROUND

Industry trends show that credit and debit cards are becoming the preference of more and more consumers in the marketplace. In 2003, for example, consumers made more payments using electronic payment methods than with cash or check-based payment methods. Surveys show that more than 37 million Americans have made point-of-sale (POS) purchases with a card for $5 or less, and the number of Americans making online purchases with a card has grown from 4 million to 14 million in less than a year. Additionally, contact-less payment cards based on radio frequency identification (RFID) technology are under development and may accelerate these consumer trends.

The volume of small payments in the physical POS (e.g. retail card reader, cash register, bar code scanner, etc.), digital (e.g. online, etc.), and mobile (e.g. cell phone, etc.) markets is escalating at a staggering pace. There are more than $1.3 trillion in cash payments under $5 in the US; digital payments exceed $3 billion with greater than 20% compound annual growth rate (CAGR); mobile payments exceed $0.5 billion with greater than 100% CAGR; and the world-wide opportunity is even larger.

While there is substantial merchant interest in small payment business models, potential problems may hinder the production of a profitable business based on small payments. For example, high transaction processing costs may have a negative impact on business profitability. Typical transaction processing costs may be $0.25+2% of the transaction. For a low-priced transaction of $1.00 the transaction processing cost can be as high as $0.27, or 27% of the transaction. This is a substantial transaction cost for the merchant that makes it difficult to have a profitable business. Some financial industry sources report that overall handling costs for payment transactions range from $0.20 to $0.40, and that the industry loses money on transactions below $10.00.

Along with transaction costs, customer support costs may also have a substantial impact on revenue and profits. For example, conventional customer service costs typically range from $5.00 to $10.00 per incident for telephone support, and $15.00 to $30.00 per incident for payment-related support resulting in a chargeback. Providing high-quality customer support is a critical part of developing and growing a business. However, high customer support costs reduce profitability.

Merchants can also incur significant marketing expenses to attract and retain customers. To mitigate this issue, merchants are interested in flexible and cost-effective ways to establish frequent consumer purchases. For example, merchants may produce compelling new products and services, implement no-hassle policies, establish integrated loyalty and rewards programs, initiate targeted promotions (sometimes with third party partners), etc.

Merchants have created a variety of payment options for their customers. Such options include, for example, pre-payment plans, in which a merchant supplies a merchant-specific instrument (e.g. a magnetic swipe card) having a desired balance “loaded” onto the card. In this model, a consumer pre-purchases a set of transactions. From the merchant's point of view this model may be advantageous since the consumers commit to more than one transaction with the merchant, and may often exceed their initial commitment. Pre-payment enables the merchants to reap the benefits of many small sales while receiving the money in a single transaction, saving on the micro-payment transaction costs. Furthermore, a card can be “re-loaded” or “topped-up” to replenish a diminishing balance, and can be tuned to amortize transaction costs over many micro-transactions. Pre-payment also provides a platform for promotional activities including volume discounts, gift cards and accounts, teen accounts, and other offerings that reach the un-banked.

Along with these advantages, the pre-paid model also poses challenges for the merchant. For example, the expenses of issuing a branded pre-paid card may be substantial and include: $2-$3.00 for card issue and charging costs at the POS; 15-40% for distribution to a card-rack at the POS; 2% per-transaction costs; and customer support costs. In addition, cost of complying with emerging regulations, such as state-imposed escheatment of unclaimed pre-paid funds, is another challenge. These start-up and run costs discourage most small and medium sized merchants from offering this payment plan to their customers.

Consumers want to purchase goods and services with their preferred and trusted credit and debit cards. However, consumers also want the benefits provided by merchant loyalty or rewards programs. While many merchants do not offer rewards programs, consumers may not want to carry the additional cards necessary to access the programs that do exist.

Many of the payment methods described above are implemented with computers, which have been networked to exchange data between them for decades. One important network, the Internet, comprises a vast number of computers and computer networks interconnected through communication channels. The Internet is used for a variety of reasons, including electronic commerce, exchanging information such as electronic mail, retrieving information and doing research, and the like. Many standards have been established for exchanging information over the Internet, such as electronic mail, Gopher, and the World Wide Web (“WWW”). The WWW service allows a server computer system (i.e., web server or web site) to send graphical web pages of information to a remote client computer system. The remote client computer system can then display the web pages. Each resource (e.g., computer or web page) of the WWW is uniquely identifiable by a Uniform Resource Locator (“URL”). To view a specific web page, a client computer system specifies the URL for that web page in a request (e.g., a HyperText Transfer Protocol (“HTTP”) request). The request is forwarded to the web server that supports that web page. When that web server receives the request, it sends the requested web page to the client computer system. When the client computer system receives that web page, it typically displays the web page using a browser. A browser is typically a special purpose application program for requesting and displaying web pages.

Currently, web pages are often defined using HyperText Markup Language (“HTML”). HTML provides a standard set of tags that define how a web page is to be displayed. When a user makes a request to the browser to display a web page, the browser sends the request to the server computer system to transfer to the client computer system an HTML document that defines the web page. When the requested HTML document is received by the client computer system, the browser displays the web page as defined by the HTML document. The HTML document contains various tags that control the display of text, graphics, controls, and other features. The HTML document can contain URLs of other web pages available on that server computer system or on other server computer systems.

New protocols exist, such as Extensible Mark-up Language (“XML”) and Wireless Access Protocol (“WAP”). XML provides greater flexibility over HTML. WAP provides, among other things, the ability to view web pages over hand-held, wireless devices, such as cell phones and portable computers (e.g. PDA's). All of these protocols provide easier ways to provide information to people via various data processing devices. Additionally, the prevalence of electronic commerce in the marketplace has accelerated rapidly due to the ease and transportability of these protocols. Many other protocols and means for exchanging data between data processing devices continue to develop to further aid the exchange of information and purchasing power.

### BRIEF DESCRIPTION OF THE DRAWINGS

FIG. 1 is a block diagram of a basic and suitable computer that may employ aspects of the invention;

FIG. 2A is a block diagram illustrating a simple, yet suitable system in which aspects of the invention may operate in a networked computer environment;

FIG. 2B is a block diagram illustrating an alternative system to that of FIG. 2A;

FIG. 3 is a schematic block diagram illustrating a payment processing system for implementing financial transactions in accordance with an embodiment of the invention;

FIG. 4 is a schematic block diagram illustrating a payment processing system in accordance with another embodiment of the invention;

FIG. 5 is a flow diagram illustrating a method of opening, funding, managing and/or using a merchant-specific virtual prepaid account in accordance with an embodiment of the invention;

FIG. 6 is a flow diagram illustrating of a method of opening, funding, managing and/or using a merchant-specific virtual subscription account in accordance with one embodiment of the invention;

FIG. 7 is a flow diagram illustrating of method of opening, rewarding, managing and/or using a merchant-specific rewards account in accordance with one embodiment of the invention;

FIG. 8A is a schematic block diagram illustrating a payment processing system in accordance with another embodiment of the invention;

FIG. 8B is a block diagram illustrating functional modules that can be included in the processors of the system of FIG. 8A;

FIG. 9 is a schematic block diagram illustrating a payment processing system in accordance with yet another embodiment of the invention; and

FIG. 10 is a schematic block diagram illustrating a payment processing system in accordance with a further embodiment of the invention.

The headings provided herein are for convenience only, and do not necessarily affect the scope or interpretation of the invention.

### DETAILED DESCRIPTION

Various embodiments of the present invention are directed to computer-implemented methods and systems for performing financial transactions with credit cards, debit cards, and other instruments. As described in greater detail below, in at least one embodiment of the invention, a payment processing system for use by financial institutions provide merchant-specific accounts to consumers that are accessed by a credit card or other preferred payment instrument. In one embodiment, the payment processing system can include a computer network for transmitting payment processing commands, a POS station associated with a merchant, and a transaction server associated with the financial institution and configured to create and/or manage merchant-specific accounts that are linked to credit cards or other payment instruments.

In various embodiments, the consumer can pay the merchant for the purchase transactions on a pay-as-you-go basis, a virtual prepaid basis, a virtual subscription basis, a post-paid basis, and/or other similar base. The merchant can, in some embodiments provide consumers with merchant rewards accounts and an opportunity to earn reward points or other loyalty based currencies through qualifying purchase transactions. The consumer can access a merchant-specific account to pay for a purchase by using a preferred payment instrument, such as a credit or debit card. In other embodiments, security methodologies can be included in the payment processing system.

The following description provides specific details for a thorough understanding and enabling description of these embodiments of the invention. One skilled in the art will understand, however, that the invention can be practiced without many of these details. Additionally, some well-known structures or functions may not be shown or described in detail, so as to avoid unnecessarily obscuring the relevant description of the various embodiments.

A. Suitable Computing Environments in which Aspects of the Invention can be Implemented

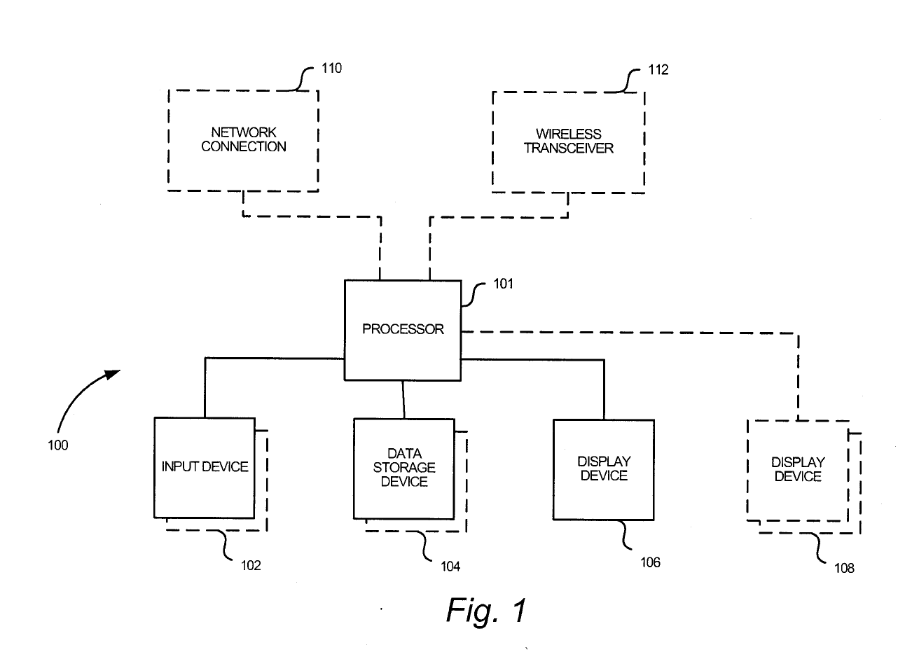

FIG. 1 and the following discussion provide a brief, general description of a suitable computing environment in which aspects of the invention can be implemented. Although not required, aspects and embodiments of the invention will be described in the general context of computer-executable instructions, such as routines executed by a general-purpose computer, e.g., a server or personal computer. Those skilled in the relevant art will appreciate that the invention can be practiced with other computer system configurations, including Internet appliances, hand-held devices, wearable computers, cellular or mobile phones, multi-processor systems, microprocessor-based or programmable consumer electronics, set-top boxes, network PCs, mini-computers, mainframe computers and the like. The invention can be embodied in a special purpose computer or data processor that is specifically programmed, configured or constructed to perform one or more of the computer-executable instructions explained in detail below. Indeed, the term “computer”, as used generally herein, refers to any of the above devices, as well as any data processor.

The invention can also be practiced in distributed computing environments, where tasks or modules are performed by remote processing devices, which are linked through a communications network, such as a Local Area Network (“LAN”), Wide Area Network (“WAN”) or the Internet. In a distributed computing environment, program modules or sub-routines may be located in both local and remote memory storage devices. Aspects of the invention described below may be stored or distributed on computer-readable media, including magnetic and optically readable and removable computer discs, stored as firmware in chips (e.g., EEPROM chips), as well as distributed electronically over the Internet or over other networks (including wireless networks). Those skilled in the relevant art will recognize that portions of the invention may reside on a server computer, while corresponding portions reside on a client computer. Data structures and transmission of data particular to aspects of the invention are also encompassed within the scope of the invention.

Referring to FIG. 1, one embodiment of the invention employs a computer 100, such as a personal computer or workstation, having one or more processors 101 coupled to one or more user input devices 102 and data storage devices 104. The computer is also coupled to at least one output device such as a display device 106 and one or more optional additional output devices 108 (e.g., printer, plotter, speakers, tactile or olfactory output devices, etc.). The computer may be coupled to external computers, such as via an optional network connection 110, a wireless transceiver 112, or both.

The input devices 102 may include a keyboard and/or a pointing device such as a mouse. Other input devices are possible such as a microphone, joystick, pen, game pad, scanner, digital camera, video camera, and the like. The data storage devices 104 may include any type of computer-readable media that can store data accessible by the computer 100, such as magnetic hard and floppy disk drives, optical disk drives, magnetic cassettes, tape drives, flash memory cards, digital video disks (DVDs), Bernoulli cartridges, RAMs, ROMs, smart cards, etc. Indeed, any medium for storing or transmitting computer-readable instructions and data may be employed, including a connection port to or node on a network such as a local area network (LAN), wide area network (WAN) or the Internet (not shown in FIG. 1).

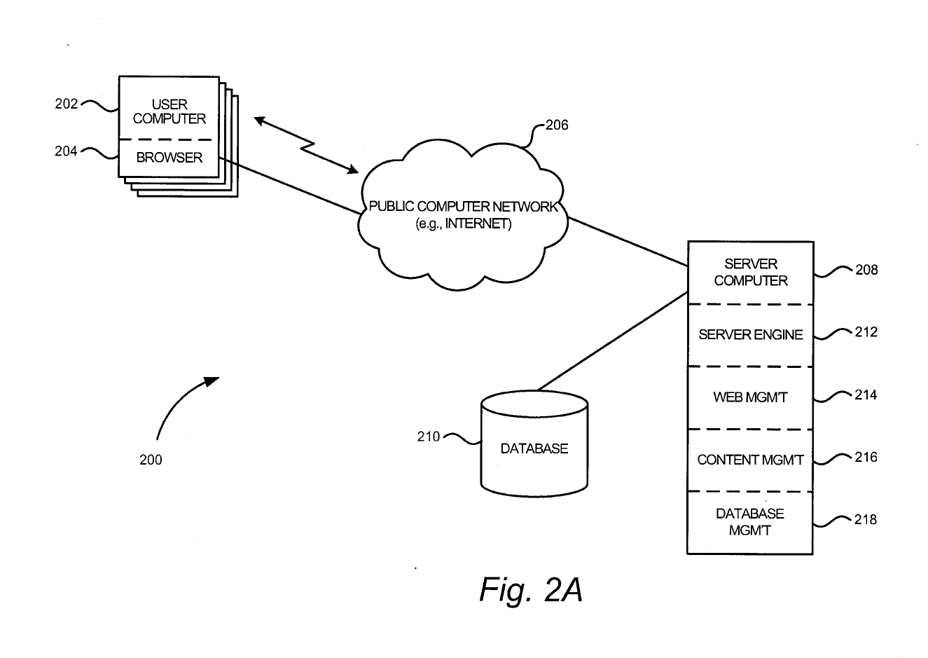

Aspects of the invention may be practiced in a variety of other computing environments. For example, referring to FIG. 2A, a distributed computing environment with a web interface includes one or more user computers 202 in a system 200 are shown, each of which includes a browser program module 204 that permits the computer to access and exchange data with the Internet 206, including web sites within the World Wide Web portion of the Internet. The user computers may be substantially similar to the computer described above with respect to FIG. 1. User computers may include other program modules such as an operating system, one or more application programs (e.g., word processing or spread sheet applications), and the like. The computers may be general-purpose devices that can be programmed to run various types of applications, or they may be single-purpose devices optimized or limited to a particular function or class of functions. More importantly, while shown with web browsers, any application program for providing a graphical user interface to users may be employed, as described in detail below; the use of a web browser and web interface are only used as a familiar example here.

At least one server computer 208, coupled to the Internet or World Wide Web (“Web”) 206, performs much or all of the functions for receiving, routing and storing of electronic messages, such as web pages, audio signals, and electronic images. While the Internet is shown, a private network, such as an intranet may indeed be preferred in some applications. The network may have a client-server architecture, in which a computer is dedicated to serving other client computers, or it may have other architectures such as a peer-to-peer, in which one or more computers serve simultaneously as servers and clients. A database 210 or databases, coupled to the server computer(s), stores much of the web pages and content exchanged between the user computers. The server computer(s), including the database(s), may employ security measures to inhibit malicious attacks on the system, and to preserve integrity of the messages and data stored therein (e.g., firewall systems, secure socket layers (SSL), password protection schemes, encryption, and the like).

The server computer 208 may include a server engine 212, a web page management component 214, a content management component 216 and a database management component 218. The server engine 212 performs basic processing and operating system level tasks. The web page management component 214 handles creation and display or routing of web pages. Users may access the server computer 208 by means of a URL associated therewith. The content management component 216 handles most of the functions in the embodiments described herein. The database management component 218 includes storage and retrieval tasks with respect to the database 210, queries to the database 210, and storage of data such as video, graphics and audio signals.

Referring to FIG. 2B, an alternative embodiment to the system 200 is shown as a system 250. The system 250 is substantially similar to the system 200, but includes more than one server computer 208 (shown as web server computers 1, 2, . . . J). A load balancing system 252 balances load on the several server computers 208. Load balancing is a technique well-known in the art for distributing the processing load between two or more computers, to thereby more efficiently process instructions and route data. Such a load balancer can distribute message traffic, particularly during peak traffic times.

A distributed file system 254 couples the web servers to several databases 210 (shown as databases 1, 2 . . . K). A distributed file system 254 is a type of file system in which the file system itself manages and transparently locates pieces of information (e.g., content pages) from remote files or databases and distributed files across the network, such as a LAN. The distributed file system also manages read and write functions to the databases.

Many of the functional units described herein have been labeled as modules, in order to more particularly emphasize their implementation independence. For example, modules may be implemented in software for execution by various types of processors, such as processor 101. An identified module of executable code may, for instance, comprise one or more physical or logical blocks of computer instructions which may, for instance, be organized as an object, procedure, or function. The identified blocks of computer instructions need not be physically located together, but may comprise disparate instructions stored in different locations which, when joined logically together, comprise the module and achieve the stated purpose for the module.

A module may also be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

A module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

### B. Embodiments of Methods and Systems for Implementing Financial Transactions

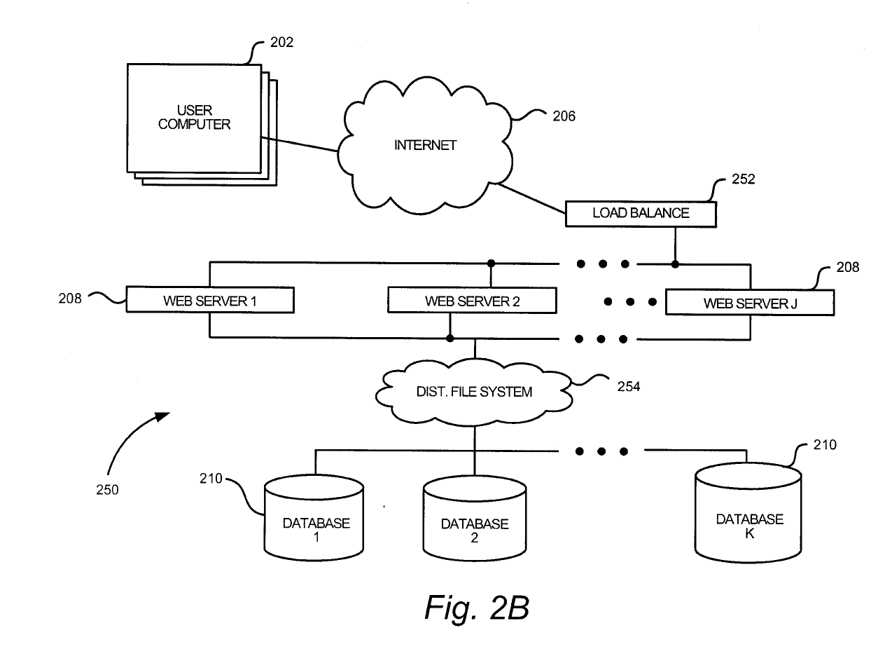

FIG. 3 depicts a payment processing system 300 for implementing electronic transactions associated with consumer accounts in accordance with an embodiment of the invention. Use of the system 300 can substantially reduce the transaction costs of low-priced purchases while increasing the convenience of having multiple payment alternatives available with a single payment instrument (e.g., a credit or debit card). The system 300 includes a transaction server 302, which can be substantially similar to server 208, in communication with a POS station 304 through a computer network 306. The computer network 306 can be substantially similar in structure and function to computer network 206. The transaction server 302 can be in communication with a data storage device 308. The system 300 can also include a personal computer 310, a workstation 312, a laptop computer 314, a printer 316, and/or other devices in communication with the transaction server 302 through the computer network 306.

The POS station 304 typically comprises a computer. However, the term “POS station” is intended to encompass other electronic devices known in the art for communicating with the computer network 306. For example, the POS station 304 can include a cash register, a computer, a terminal, a bar code scanner, a card reader, a keypad, a signature capture device, and the like. The POS station 304 can be located at a merchant and comprise a check stand with an array of POS equipment or may be a POS system, such as a mainframe computer or workstation hosting a website offering merchandise or services for purchase.

The POS station 304 is capable of communicating a transaction through the computer network 306 to the transaction server 302 and a card payment network 318 for credit approval and other transaction-related communications. In one embodiment, transactions can be received from POS devices that operate at the merchant-attended physical POS, and are designed to funnel card-present transactions to the card payment network 318. Kiosk devices that operate at the merchant-unattended physical POS and conduct card-present transactions can also route transaction to the card payment network 318.

Electronic payment transactions from Internet websites or webpages (or other types of eCommerce systems) that conduct remote transactions in which a physical card is not presented to a merchant, are also supported by the system 300. Mobile interfaces (e.g., cell phones) to mobile commerce applications, that conduct a mix of physical card and remote transactions, can provide portals for electronic payment transactions that can be implemented by the system 300. Consumers can also purchase products and/or services using the telephone. In these situations, an account number associated with the card is typically used to complete the transaction. One of ordinary skill in the art will recognize that the POS station 304 and the networks 306 and 318, can include other add-on systems arranged in other ways without departing from the spirit or scope of the present invention.

A first banking institution (not shown), such as an acquiring bank, can provide merchants with accounts for accepting payments. A second banking institution (also not shown), such as an issuing bank, can provide consumers with instruments (e.g., a credit cards, debit cards, prepaid cards, etc.) for making electronic payments. In this embodiment, the card payment network 318 manages the relationships between the issuing bank and the acquiring bank. In some embodiments, a third party known as a processor can handle transactions among merchants, acquiring banks, issuing banks, and other associated entities. Throughout this disclosure, acquiring banks, issuing banks, associations, and processors may be referred to as financial service institutions 320.

In one embodiment, the transaction server 302 can be in direct communication with the card payment network 318, which is operatively connected to the financial service institutions 320 for authorization and capture of payments. In another embodiment, the computer network 306 can be in direct communication with the payment card network 318.

In one embodiment, the transaction server 302 can include an account activation module 322, a fund request module 324, an account management module 326, and a virtual debit module 328. In other embodiments, the transaction server 302 can also include one or more additional modules, such as a customer loyalty module 330 and a consumer self-service module 332, all of which will be described in detail below. The account activation module 322 can be included for allowing a user to activate a new merchant-specific account and link that account to an existing instrument/card. The account activation module 322 can be configured to receive merchant requests for account activation and linkage based on the provided options of different methodologies for making payments, such as virtual prepaid and virtual subscription.

The account activation module 322 can provide a personalized payment choice for merchants to have the ability to define a set of “Account Types” that they accept as payment within the business. Account types may be specific to the merchant, for example, one merchant may define a virtual prepaid account for phone time while another merchant defines a virtual subscription account for downloading music. Different account types can have different underlying “unit types”, which are the units of the balance in the accounts (e.g., U.S. dollars, minutes of phone time, minutes of game time, candy bars, etc.). The extensible set of unit types allows for the implementation of loyalty currencies.

Accounts, which are instances of an account type, are typically owned by a consumer and backed by an “instrument.” The instrument serves to identify the consumer, and may be a key basis for authenticating access to the account. Examples of instruments include credit cards, debit cards, gift cards, RFID-based smart cards, RFID-based mobile tokens, website account identifiers, etc. The instrument, or card, is the source of macro-payment funds in the system, and can in fact be the only token identifying the consumer for this account. In some embodiments, consumers can optionally have a login (name, password), and can associate that login with one or more instruments and the accounts associated with the instruments.

In one embodiment, the fund request module 324 can be configured to communicate with the large-scale processors of the acquiring bank and/or the card payment network 318. The fund request module 324 can initiate authorization commands for requesting a transfer of funds from a cardholder's issuing bank to the merchant-owned account at the acquiring bank. Capture of these funds by the fund request module 324 corresponds to a deposit of units of value in a consumer's new merchant-specific account.

In some embodiments, a virtual prepaid account is funded with dollars, or another monetary unit, when the fund request module 324 receives funds from the consumer's primary account or other funding source. In other embodiments, the fund request module 324 can receive funds from the consumer's primary account or other funding source and deposit other units of value into the consumer's merchant-specific account, such as a virtual subscription account. Additionally, the fund request module 324 can be authorized to deposit more units of value into the consumer's merchant-specific account than the amount of funds actually received from the funding source. In these instances, the merchant may have authorized the fund request module 324 to do this as an incentive for consumers to activate and fund a merchant-specific account. The fund request module 324 can be authorized at any time or on a regular schedule to request and receive funds for purposes of increasing a merchant-specific account balance and/or maintaining an active status of the merchant-specific account.

The transaction server 302 can also include an account management module 326 configured to execute one or more routines for managing a mix of account types linked to a payment instrument. When a consumer uses an instrument to make a purchase at a merchant POS station 304, or other electronic transaction computer, the account management module 326 can receive a request for account verification and account type.

In one embodiment, the consumer can present a card or other instrument to the merchant as the desired method of payment. The merchant can swipe the card or otherwise enter account information at the POS station 304. In one embodiment, the account management module 326 accesses associated accounts in the financial institution 320 on a priority order specified by the merchant. In another embodiment, the priority order can be specified by the consumer. For consumers having multiple accounts accepted by a merchant, the account management module 326 can facilitate access to all these accounts such that the payment transaction amount can be divided between the accounts in a desired format. In some instances, the account management module 326 can be configured to report account status to the merchant and/or consumer.

Once the correct account in the financial service institution 320 is accessed by the account management module 324, the virtual debit module 328 debits the account balance by the appropriate purchase amount. If more than one account is accessed, the virtual debit module 328 debits each account by the desired amount. After debiting the account, the virtual debit module 328 can calculate the remaining account balance and report the balance to the merchant and/or the consumer. In another embodiment, the account management module 326 can report account balances.

The customer loyalty module 330 can be configured to activate merchant rewards accounts. In some embodiments, the customer loyalty module 330 can automatically activate a rewards account and enroll a customer in merchant-specific loyalty program. In other embodiments, the customer loyalty module 330 can be configured to prompt a user to manually activate a rewards account.

The transaction server 302 can also include the consumer self-service module 332 that allows consumers to track and manage their instrument-linked accounts. Consumer self-service module 332 can provide online access to account balances and transaction details providing consumers with a gratifying system in which to make and track their purchases. The consumer self-service module 332 can also be configured to provide mechanisms for transaction dispute resolution.

As described in greater detail below, the payment processing system 300 can enable consumers to make purchases with their preferred payment instrument (e.g. a credit card, a debit card, a payment intermediary such as Paypal, etc.), while efficiently processing transactions of any size. The transaction server 302 can also provide a payment card gateway capable of handling payments for various types of business models.

Typically, consumers want purchasing flexibility. They want to control what they buy, when they buy it, and how they pay for it. Merchants want to make it easy for consumers to buy their goods and/or services and establish customer loyalty. But for smaller transactions, card processing and customer service costs eat much—if not all—of the merchant's profits. When the consumer uses a preferred credit or debit card to pay for low-priced items, the merchant's profits may disappear. To prevent this, merchants frequently impose restrictions on credit or debit card usage for small payments. As a result, these cards may not offer the convenience that consumers desire.

The payment processing system 300 enables profitable transactions for small payments and allows merchants to craft business-model offerings, such as merchant reward and loyalty programs, that increase consumer acceptance. Additionally, merchants receive the cost and customer satisfaction benefits of customer self-care.

Acquiring banks and payment processors may be interested in offering products that meet the needs of merchant customers and increase overall transaction volumes. However, acquiring banks and transaction processors have typically been unable to provide merchants with (1) cost-effective solutions for small payments, and/or (2) merchant reward and loyalty programs. Disproportionately high fixed and variable fees associated with traditional payment processing adversely affect merchant profit margins. The alternatives, such as implementing the use of merchant-specific prepaid cards or minimum purchase amounts, may impose economic or time disincentives on consumers and merchants alike.

By incorporating the functionality of the transaction server 302 into existing systems, processors and acquiring banks can enable profitable new business models for merchants. In addition, merchants can accept preferred payment instruments (e.g., credit cards, debit cards, etc.) for access to several payment plans and consumer-owned accounts. With a new class of transactions flowing through the system, processing volume may grow, and with it revenue for the acquiring bank and the processor.

In general, the transaction server 302 can be integrated into existing processing systems, and the POS systems operated by merchants. For acquiring banks and processors, the payment processing system 300 may increase transaction flow, bringing both revenue and profit benefits. Additionally, the ease of employment and ubiquitous nature of the system removes an impediment to merchant rollout of preferred payment oriented plans such as pre-payment plans, subscription plans, merchant reward and loyalty programs, etc.

Issuing banks want their cards to be at the “top of wallet” whenever cardholders make a purchase. But for small purchases, high processing and customer service costs discourage merchants—both digital and physical—from accepting credit and debit cards. As a result, the issuing bank may lose market share to cash and alternative payment systems.

With the functionality of the payment processing system 300, cardholders can experience the convenience of using cards instead of cash to purchase low-priced goods. The purchasing process is familiar and quick, and may not require additional account registration and access instruments. The payment processing system 300 allows several account types to be linked to a single card or other instrument. Real-time customer service responses are known to incur great expense for issuing bank enterprises in many conventional systems. The payment processing system 300 can provide responsive service at a relatively low cost by offering online customer self-service, specifically designed for small payments and multiple account types. For issuing banks, the payment processing system 300 provides mechanisms to convert cash and check spending as well as merchant-specific prepaid account spending to transactions associated with their cards, thereby increasing transaction flow. By giving consumers access to multiple accounts, including customer rewards accounts, through a single transaction card, issuing banks bring “top-of-wallet” market share gains to the cards that consumers use.

In some arrangements, the transaction server 302 provides an expandable transaction processing platform that enables merchants, acquiring banks, issuing banks, processors and associations to grow and develop through a system providing multi-account management. By efficiently and economically operating on small payments through intelligent aggregation of pay-as-you-go, virtual prepaid, virtual subscription, or post-paid payment architectures, the transaction server 302 can substantially reduce the transaction costs of low-priced purchases.

The transaction server 302 allows implementation of incentives for consumers to make purchases with their preferred payment instrument (e.g., credit card, debit card, etc.). By functioning in either digital, mobile, or physical POS environments, operations of the transaction server 302 can integrate seamlessly into the merchant buying experience as a credit-card gateway, with no visible change in consumer buying experience. Through its operations, the merchant is given a tool to build a profitable relationship with their customers through a blend of potential business models, including virtual prepaid and virtual subscription accounts, which are described in greater detail below. Additionally, the transaction server 302 can also improve customer satisfaction and lower customer service costs through integrated bill presentment and dispute resolution. Along with lower transaction costs, use of the transaction server 302 can bring cost-effective loyalty, promotions, fraud management, and other technologies to the small payment market.

The transaction server 302 can reside and/or be fully integrated on the premises of large-scale processors operated by financial service institutions 320 such as acquiring and issuing banks. The transaction server 302 can enable near-seamless integration into the existing business processes of large-scale processors. The transaction server 302 can support existing processes for adding partners (Acquirers, ISOs, and Agents) and allow each partner to shape and control the small payment processing products deployed by their merchant customers. The transaction server 302 can support the processor billing process, so that the processor and associated partners can operate successfully. Additionally, the transaction server 302 can include a consumer self-service functionality that can be integrated with the processor's other consumer-facing portal offerings. Beneficially, the transaction server 302 can provide the ability of acquiring banks to link virtual prepaid, virtual subscription, and customer rewards accounts to an existing consumer primary card account.

For each type of client mentioned above, there are a variety of architectures for interfacing merchant applications to the payment processing system 300. For example, for client-side customization, the business logic that adapts the client to the payment processing system 300 can be coded in a client server or a server associated with the merchant. The business logic that adapts the client to the payment processing system 300 can be implemented at an interposing server that may be located between the client and the party that controls the system 300. The business logic that adapts the client to the payment processing system 300 can also be implemented as a server-side module (e.g., a plug-in module) to the payment processing system 300 via merchant plug-ins. Also, one or more of the financial service institutions 320, included in the payment processing system 300, can transparently integrate the transaction server functionality into the systems of an existing payment processor. Such an integration can include minimal (or substantially no) changes to the systems of the merchants that are already using pre-existing payment processors.

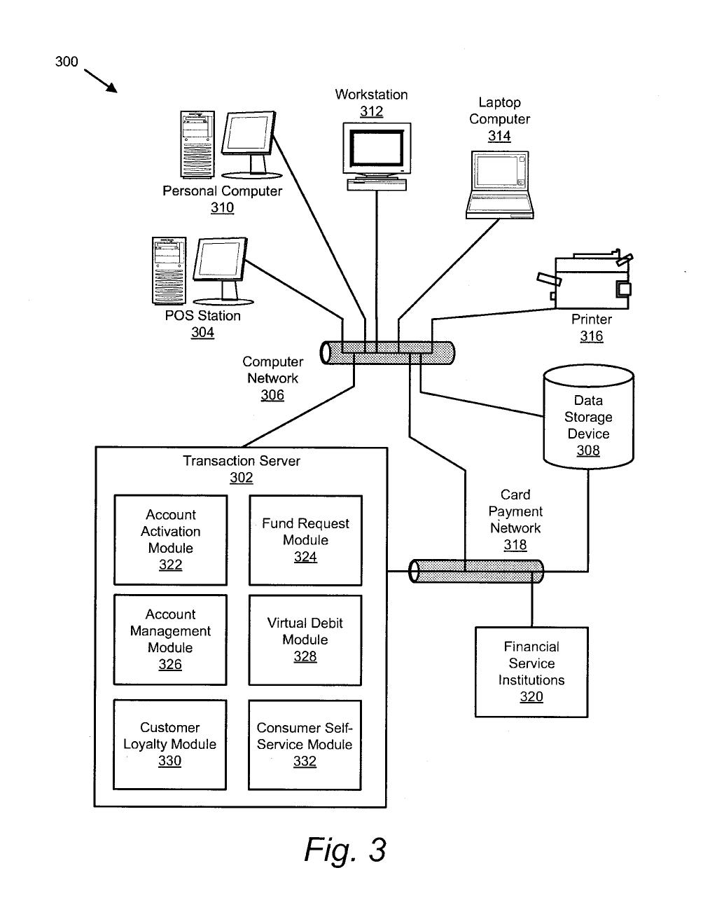

FIG. 4 is a schematic diagram of a payment processing system 400 configured in accordance with an embodiment of the invention. The payment processing system 400 can include the transaction server 302, which communicates with a merchant 402 and is integrated with an acquiring bank 404. The payment processing system 400 can further include a consumer 406 that presents an instrument 408 (e.g. a card) to the merchant 402. The merchant 402 can send the instrument information to the transaction server 302. An account activation module 322 receives the information, validates the instrument 408, and returns a personalized payment profile associated with the instrument 408. The profile can describe an extensible list of accounts that have been defined to work with the instrument 408, along with parameters defining how new accounts can be linked to the instrument 408.

The merchant 402 uses the information in the profile to present a payment experience to the consumer 406 that is customized to the consumer's preferences and the merchant's defined business models. The consumer 406 completes the purchase transaction as desired, and the merchant 402 captures the funds from the consumer as determined by the chosen payment account. A first transaction can require the fund request module 324 to request funds from a consumer-associated issuing bank funding source 410 through a card payment network 412. Typically, single-account purchases that correspond to standard payment card transactions are made; however, compound, multi-account, purchases can also be supported. For example, a multi-account purchase can combine a US dollar transaction with a loyalty point update, or a Japanese yen transaction with a free coffee.

C. Embodiments of Methods and Systems for Opening, Funding, Managing, and/or Using Merchant-Specific Transaction Accounts Associated with a Card or Other Payment Instrument

1. Virtual Prepaid Accounts

Merchant prepaid or stored value cards are well-known mechanisms for making electronic transactions. Consumers purchase prepaid cards from a merchant, load it with a desired balance from a funding source, and access that balance by presenting the prepaid card at the POS. Merchants deduct transaction amounts from the prepaid total. If they desire, consumers can opt to replenish (top-up) the diminished balance by loading additional value onto the card. While this payment model may be attractive to merchants as a way to decrease transaction costs associated with micro-payments, the high costs and complexity of implementing, distributing and maintaining a proprietary stored value card system may be impediments for many merchants. Additionally, consumers are required to carry, and risk losing, extra cards for each prepaid merchant account they have opened.

In one embodiment, the present invention provides for a virtual prepaid account linking a merchant prepaid value to an existing payment instrument (e.g. credit or debit card). Consumers purchase the virtual prepaid account from the merchant and fund the account with value from a desired funding source. The funding source can be accounts already linked to the credit or debit card. The virtual prepaid account can be accessed by the merchant via the instrument. At the POS, the consumer presents the instrument to the merchant. The merchant swipes the card, or otherwise enters card information, and the value of the transaction is decremented from the virtual prepaid account and balance information is returned to the consumer, via, a receipt for example. If the consumer elects, the virtual prepaid account can be automatically topped-up from the funding source as it is used.

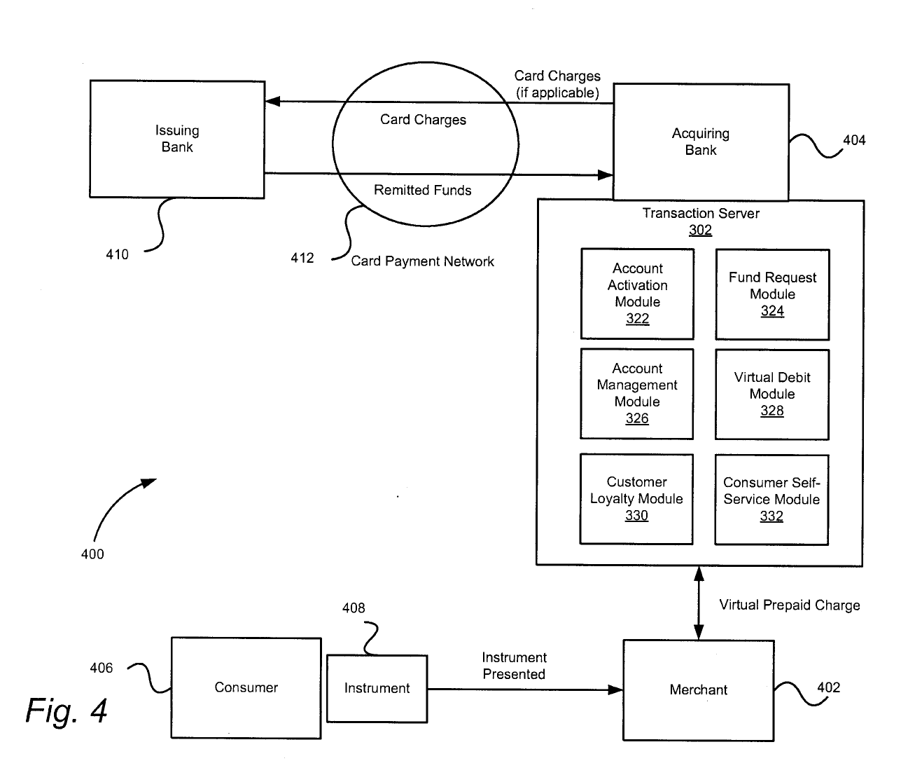

FIG. 5 is a flow diagram of a routine 500 for opening, funding, managing and/or using a merchant-specific virtual prepaid account in accordance with an embodiment of the invention. In one aspect of this embodiment, the routine 500 can be at least partially performed by a person wishing to open a merchant-specific virtual prepaid account at a POS station (e.g. the POS station 304 of FIG. 3). In other embodiments, the routine 500 can be performed by other entities using other networked and non-networked devices to open other types of financial and non-financial accounts.

The routine 500 begins 502 and the account activation module 322 receives 504 a request to initiate a PREPAY function to open a virtual prepaid account. In response to the request, the account activation module 322 creates 506 a virtual prepaid account and links 508 the account to a payment instrument. The fund request module 324 charges 510 the instrument for an initial deposit amount. In one embodiment, charging 510 the instrument can include requesting authorization and capturing funds through the card payment network 318. In this embodiment, charges are passed through the acquiring bank to the issuing bank. If the charge is approved, the issuing bank forwards funds to the acquiring bank. The acquiring bank deposits 512 funds into the merchant's bank account. In another embodiment, however, a different funding source can be used to fund the virtual prepaid account (e.g. cash may be provided by the consumer to fund the virtual prepaid account). The fund request module 324 subsequently records 514 the initial prepaid deposit in the virtual prepaid account, and the merchant retains the funds.

Once a virtual prepaid account is activated and funded, a consumer presents 516 the payment instrument (e.g., a credit or debit card) to the merchant to initiate a virtual prepaid purchase. Standard application programming interface (API) commands, such as AUTH, CAPT, SALE, CRED, and VOID can be used for virtual prepaid transactions. In one embodiment, the merchant enters 518 the linked card track data into the POS station 304 by a card swipe. In other embodiments, the linked card information can be communicated by card account number, or by a merchant-supplied account ID. The account management module 326 identifies 520 the instrument-linked accounts and accesses 522 the merchant-specific virtual prepaid account. If several accounts are available to provide payment for a transaction, the account management module 326 accesses 522 the accounts in a priority order specified by the merchant. In other embodiments, the consumer can specify a priority order. The virtual debit module 328 debits 524 the amount of each purchase from the balance in the virtual prepaid account. A payment amount associated with a purchase can be divided among several linked accounts or non-linked funding sources if the merchant has configured their business model to operate in this manner. In this scenario, the virtual debit module 328 debits 524 each linked account for the amount specified by the merchant. In operation, the account management module 326 and the virtual debit module 328 can be configured to provide transaction API messages for virtual prepaid purchases that are substantially the same format as for pay-as-you-go payment methods. The virtual debit module 328 calculates 526 the remaining balance in the virtual prepaid and/or other linked accounts. In one embodiment, the account management module 326 reports 528 the account balance to the merchant and/or the consumer. Account balances can be printed on transaction receipts or reported in conjunction with confirmation codes for online transactions.

The virtual prepaid account balance can be increased (topped-up) at any time through instructions to the fund request module 324. In another embodiment, the merchant my obtain the consumer's contractual consent in advance to automatically top-up or increase the balance of a virtual prepaid account when a low threshold balance is achieved in the account. In this embodiment, the account management module 326 can be configured with a TOP-UP function that triggers 530 the fund request module 324 to charge 510 the funding source for additional funds to deposit in the merchants bank account. In some embodiments, merchants can choose to provide incentives to customers to participate in an automatic top-up agreement, for example depositing $12 in value in the customers virtual prepaid account for a $10 top-up transaction. After this, the routine 500 ends 532. In other embodiments, the routine 500 can end 532 following steps 514, 528.

One advantage of the method described above for opening, funding, managing and using a new virtual prepaid account associated with a merchant is that the consumer may use their preferred and trusted card/instrument to establish a prepaid account at a physical POS for the frequent, everyday purchases (e.g. coffee, parking, convenience items, etc.) which traditionally have been made with cash. Consumers do not have to print, fill out, and sign one or more documents and submit them to a merchant or a financial service institution to open the new virtual prepaid account. Instead, all of the necessary actions on the part of the applicant can be performed at the POS station or online. Once the all the necessary activation and funding steps have been completed and the initial deposit has been recorded, the consumer can use the linked card to access the virtual prepaid account in a manner that is seamless at the POS location. Because there are no additional cards to carry or lose, the foregoing method of the present invention can also reduce the inconveniences of conventional, card-based stored value programs.

2. Virtual Subscription Accounts

The virtual subscription account type, which is based on a subscription business model, is similar to the virtual prepaid account type described above. The subscription business model is widely used in a variety of markets, from newspaper and magazine publishing to mass transit to online services and book-of-the-month clubs. Consumers establish an account with a merchant, and are periodically charged for access to the account on an agreed-upon basis. Subscription plans are typically either “unlimited” (e.g. a monthly transit pass), or “metered” (e.g. a 500 minute per month cell phone plan).

Embodiments of the invention provide for a virtual subscription account linking a merchant membership account to a consumer's existing credit or debit card (payment instrument). Consumers establish the virtual subscription account with the merchant, paying account charges with the credit or debit card (or some other funding source). In one embodiment, the consumer presents the credit or debit card to the merchant, the purchase checks that the account is still active and decrements the value of the transaction from the virtual subscription account and balance information is returned to the consumer. Other usage accounts are also supported and would only require verifying account status. The consumer's instrument may be periodically charged, and the virtual subscription account is periodically topped-up with value (e.g. cell phone minutes, subway rides, gym membership access, etc.). The charge and deposit periods can be independent of one another, for example, virtual subscription charges may occur prior to access to the deposited value.

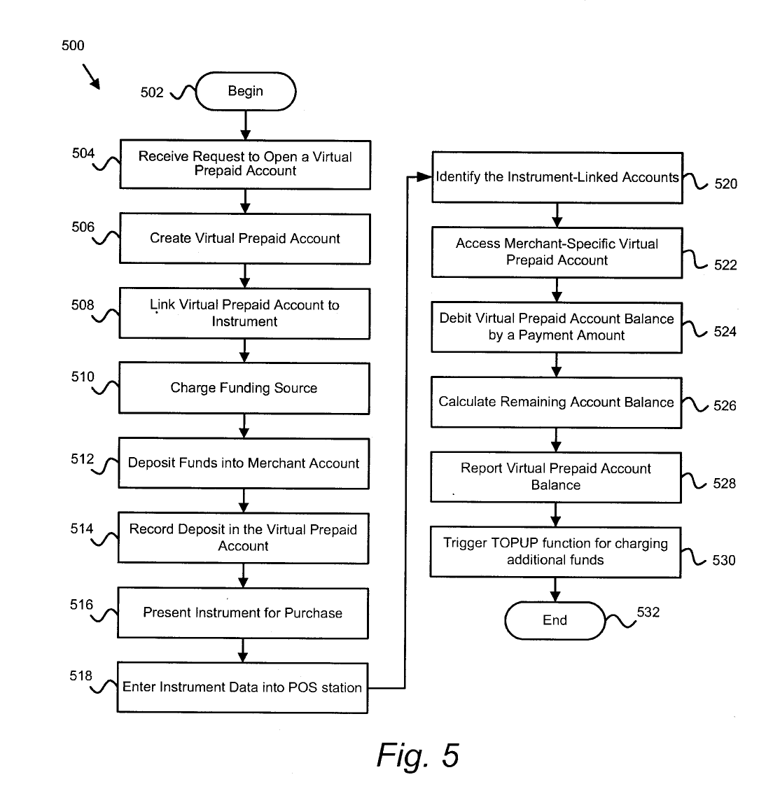

FIG. 6 is a flow diagram of a routine 600 for opening, funding, managing and/or using a merchant-specific virtual subscription account in accordance with an embodiment of the invention. In one aspect of this embodiment, the routine 600 can be at least partially performed by a person wishing to open a merchant-specific virtual subscription account at a POS station (e.g. the POS station 304 of FIG. 3). In other embodiments, the routine 600 can be performed by other entities using other networked and non-networked devices to open other types of financial and non-financial accounts.

The routine 600 begins 602 and the account activation module 322 (FIG. 3) receives 604 a request to initiate a SUBSCRIBE function to open a virtual subscription account. In response to the request, the account activation module 322 creates 606 a virtual subscription account and links 608 the account to a payment instrument. The account activation module 322 also defines 610 a payment schedule for access to the subscription. Next, the fund request module 324 charges 612 the instrument according to the defined schedule. In one embodiment, charging 612 the instrument can include requesting authorization and capturing funds through the card payment network 318. In this embodiment, charges are passed through the acquiring bank to the issuing bank. If the charge is approved, the issuing bank forwards funds to the acquiring bank, and the acquiring bank deposits 614 funds into the merchant's bank account. In another embodiment, however, a different funding source can be used to pay for the virtual subscription account (e.g. cash provided by the consumer to pay for activation of the virtual subscription account). The fund request module 324 subsequently records 616 the subscription payment and the account activation module 322 activates 618 the virtual subscription account and deposits 620 units of value in the virtual subscription account. For an “unlimited” subscription plan, value may simply be access to the items or services provided by the merchant. For a “metered” subscription plan, number of units is pre-determined.

Once a virtual subscription account is activated and a payment schedule has been determined, a consumer presents 622 their linked card to obtain access to the units of value deposited in the virtual subscription account. Standard application programming interface (API) commands, such as AUTH, CAPT, SALE, CRED, and VOID can be used for virtual subscription transactions. In one embodiment, the merchant enters 624 the linked card track data into the POS station 304 by a card swipe. In other embodiments, the linked card information can be communicated by card account number, or by a merchant-supplied account ID. The account management module 326 identifies 626 the instrument-linked accounts and accesses 628 the merchant-specific virtual subscription account. If several accounts linked to a card are available to provide payment for a transaction, the account management module 326 accesses 628 the accounts in a priority order specified by the merchant. In other embodiments, the consumer can specify a priority order. If a virtual subscription account has an unlimited balance, the account management module 326 accesses 628 the account and verifies 630 the activity status.

If the virtual subscription account is “metered”, the virtual debit module 328 debits 632 the number of units of value consumed during the transaction from the unit balance in the virtual subscription account. A payment amount associated with a subscription transaction can be divided among several linked accounts or non-linked funding sources if the merchant has configured their business model to operate in this manner. In this scenario, the virtual debit module 328 debits 632 each linked account for the amount specified by the merchant. For example, if a consumer has a magazine subscription and a book of the month club subscription with the same merchant, a single swipe of the card would access both accounts such that the consumer may enjoy collecting both the magazine and the book during a single transaction. The virtual debit module 328 would debit 632 both the magazine subscription account and the book-of-the-month subscription account accordingly. In other embodiments, a consumer may have a book-of-the month subscription and choose to purchase a magazine during the same transaction. The virtual debit module 328 would debit 632 the book-of-the-month subscription account and would debit 634 either a virtual prepaid account or a pay-as-you-go account for the magazine. In operation, the account management module 326 and the virtual debit module 328 can be configured to provide transaction API messages for virtual subscription transactions that are substantially the same format as for pay-as-you-go payment methods. The virtual debit module 328 calculates 634 the remaining unit balance in the virtual subscription and/or other linked accounts. In one embodiment, the account management module 326 reports 636 the account balance to the merchant and/or the consumer. Account balances can be printed on transaction receipts or reported in conjunction with confirmation codes for online transactions.

Metered virtual subscription accounts periodically have the units of value deposited into the account. The period of deposits can be asynchronous with the charge period. For example the merchant can specify a plan that charges monthly but refreshes the deposit balance daily. Metered virtual subscription accounts can be configured to with a revolving unit balance. In other embodiments, the unit balances can expire after term periods according to the conditions stipulated by the plan. Subscription renewal can be initiated at any time through explicit instruction to the fund request module 324. In another embodiment, the merchant can obtain the consumer's contractual consent in advance to automatically renew or continue the active status of the virtual subscription account. In this embodiment, the account management module 326 can be configured with a SCHEDULE function that triggers 638 the fund request module 324 to charge 612 the funding source for additional funds to deposit in the merchants bank account. In some embodiments, merchants can choose to provide incentives to customers to participate in an automatic renewal agreement, for example depositing 12 units of value in the customer's virtual subscription account for a 10 unit transaction. After this the routine 600 ends 640. In other embodiments, the routine 600 can end 640 following steps 618, 620, 630, 636.

As described above for virtual prepaid accounts, an advantage of the method described above for opening, funding, managing and using a virtual subscription account associated with a merchant is that the consumer can begin to use their preferred and trusted card/instrument to establish a subscription account at the physical POS for the regular, recurring charges which may have been previously cash-based (e.g. riding mass transit, parking, memberships, etc.). Consumers do not have to print, fill out, and sign one or more documents and submit them to a merchant or a financial service institution to open the new virtual subscription account. Instead, all of the necessary actions on the part of the applicant can be performed at the POS station or online. Once the all the necessary activation and funding steps have been completed and the initial deposit and payment schedule has been recorded, the consumer can use the card to access the virtual subscription account in a manner that is seamless at the POS location. Because there are not additional cards to carry or potentially loose, the foregoing method of the present invention can additionally reduce the annoyances of conventional card-based membership and access programs.

3. Rewards Accounts

The high cost of customer acquisition motivates merchants to encourage repeat business, to guide their customers to augment or increase their purchases, and to provide trusted communications with their customers at the time of purchase or at the customer's request. For small ticket merchants, enhancing consumer loyalty is particularly critical if they are going to recoup their proportionally higher cost of customer acquisition and achieve profitability. Loyal customers want unique benefits, and merchants wish to deliver them by automatically recognizing the customer at the time of purchase and enrolling them in a rewards system that does not have a complex registration process. Embodiments of the invention provide for implementation of merchant loyalty programs and customer rewards accounts. A customer loyalty module 330 provides for a rewards account linking a merchant reward program to a consumer's existing payment instrument (e.g. credit or debit card).

The customer loyalty module 330 can equip online and physical POS merchants with a simple, yet comprehensive approach to creating and maintaining long-lasting relationships with their customers. Consumer sophistication is leading merchants to employ specifically defined rewards systems to increase the precision of reward accumulation and disbursement, ultimately to ensure customer retention. The customer loyalty module 330 can be configured to enable this process through a rules-based approach that is linked to the consumer's preferred existing debit or credit card. For smaller, physical retailers, this eliminates the need for a “frequent customer card” that gets stamped or punched.

Rewards accounts, which are instances of an account type, maintain balances in a merchant-defined unit type, which is often “points”, but may be in any currency that merchants believe will appeal to their customers, from minutes to miles to ice cream cones. Beneficially, merchants can create and maintain rewards accounts on behalf of their customers in any unit of value denomination, and can establish precise rules that determine how rewards are earned and how they are subsequently enjoyed by their customer. The customer loyalty module 330 tracks the rewards points and provides accumulation and redemption calculation on behalf of the merchant and the customer. Additionally, the customer loyalty module 330 is configured to report the rewards account balance online or on a printed receipt, for example, and to offer coupons for various rewards to emphasize appreciation of ongoing patronage.

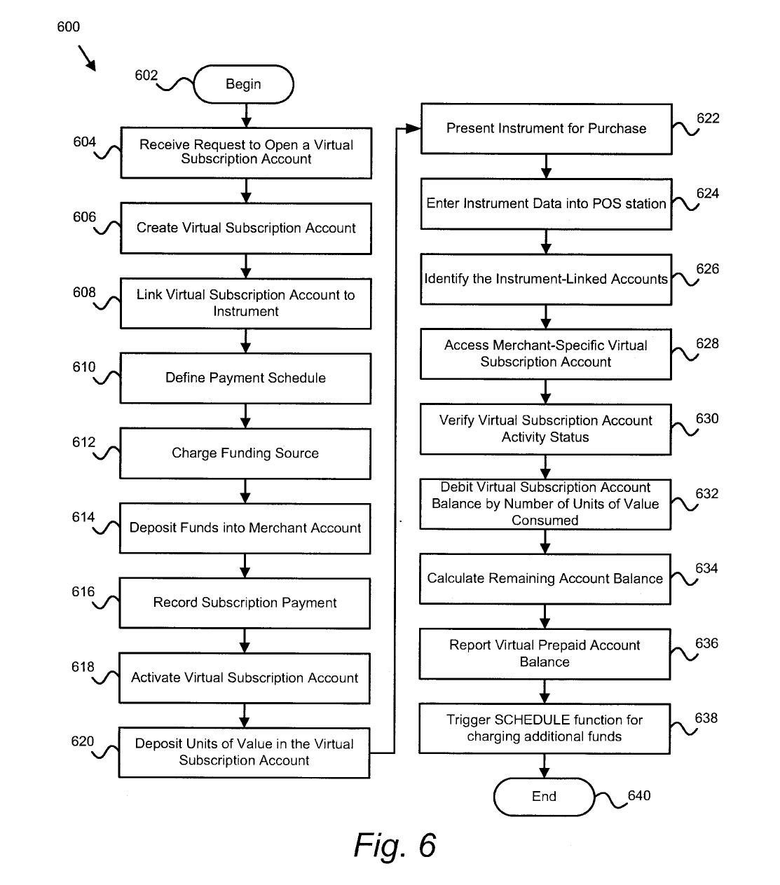

FIG. 7 is a flow diagram of a routine 700 for opening, rewarding, managing and/or using a merchant-specific rewards account in accordance with an embodiment of the invention. In one aspect of this embodiment, the routine 700 can be at least partially performed by a merchant wishing to open a merchant-specific rewards account on behalf of a customer at a POS station (e.g. the POS station 304 of FIG. 3). In other embodiments, the routine 700 can be performed by other entities using other networked and non-networked devices to open other types of financial and non-financial accounts.

The routine 700 begins 702 and the customer loyalty module 330 receives 704 a request to initiate a REWARDS function to open a rewards account. In response to the request, the customer loyalty module 330 creates 706 a rewards account and links 708 the account to a payment instrument. The request to initiate a rewards account can be automatic. For example, a consumer can have a rewards account created during the first instrument/card-initiated transaction with the merchant. In another embodiment, the consumer can elect to sign up for a rewards account.

The customer loyalty module 330 (FIG. 3) deposits 710 units of value (points) in the rewards account in a rules-based process invoked within the transaction stream. The customer loyalty module 330 can be configured with an EARNRULES function that defines and administers point earning rules. Generally, point earning rules consist of two parts, a predicate and an action. The predicate is a conjunction (logical AND) of terms. Each term can reference properties of the transaction or the customer purchase history, including properties related to customer purchase history, such as recency, frequency, and lifetime purchase amount. Other reference properties can include properties related to the transaction, such as the type of transaction, the timing of the transaction, the type of account that the transaction is being charged against (e.g. pay-as-you-go, virtual prepaid, virtual subscription), and the type of goods being purchased (down the SKU level, if that information is available).

If the predicate matches the requirements of the earning rules, the action (purchase) can trigger the deposit 710 of points in the rewards account. In one embodiment, the number of points deposited for each action can be a constant amount. In another embodiment, the number of points deposited for each action can be an amount based on a multiple of the purchase price plus a constant. Merchants can define an arbitrarily large number of earning rules. In one embodiment, all of these rules are evaluated on every transaction. In other embodiments, however, only those rules with matching predicates will result in deposit of points into the rewards account. The combination of multiple earning rules supported by the EARNRULES function of the customer loyalty module 330, each with independent predicates, can allow the transaction server 302 to support sophisticated rewards applications.

The customer loyalty module 330 can also be configured with a COUPONRULES function that defines and administers coupon earning rules. The customer loyalty module 330 issues 712 coupons to the consumer on behalf of the merchant using this function. Coupon earning rules can be defined and administered similarly to the point earning rules, however, the resulting action is the issuance of a coupon to the consumer. A coupon is a merchant-defined offer for consumers that consist of a name, a consumer-visible message, a coupon redemption point amount, and a date range during which the coupon is valid. Coupons rules, in one embodiment, have parameters that govern how often they should be presented to a consumer, whether they are unique to a particular consumer, and whether the consumer must present an instrument/card to redeem the coupon. In some embodiments, the customer loyalty module 330 assigns a unique serial number to the coupon for coupon tracking. Additionally, coupons may be presented to the consumer in a variety of ways. Coupons can be printed on transaction receipts or reported in conjunction with confirmation codes for online transactions.

Once points have been earned and deposited 710 in a rewards account, the points can be used in several ways. A rewards account can behave similarly to a virtual prepaid account denominated in a rewards currency. During a transaction, a consumer presents 714 the linked card to initiate rewards purchases from a merchant. Standard application programming interface (API) commands, such as AUTH, CAPT, SALE, CRED, and VOID can be used for rewards transactions. In one embodiment, the merchant enters 716 the linked card track data into the POS station 304 by a card swipe. In other embodiments, the linked card information can be communicated by card account number, or by a merchant-supplied account ID. The account management module 326 identifies 718 the instrument-linked accounts and accesses 720 the merchant-specific rewards account. If several accounts linked to a card are available to provide payment for a transaction, the account management module 326 accesses 720 the accounts in a priority order specified by the merchant. In other embodiments, the consumer can specify a priority order. The virtual debit module 328 debits 722 the amount of each purchase from the balance in the rewards account.

A payment amount associated with a purchase can be divided among several linked accounts or non-linked funding sources if the merchant has configured their business model to operate in this manner. In this scenario, the virtual debit module 328 debits 722 each linked account for the amount specified by the merchant. In operation, the account management module 326 and the virtual debit module 328 can be configured to provide transaction API messages for rewards purchases that are substantially the same format as for pay-as-you-go payment methods. The virtual debit module 328 calculates 724 the remaining balance in the rewards and/or other linked accounts. In one embodiment, the account management module 326 reports 726 the account balance to the merchant and/or the consumer. In other embodiments, the customer loyalty module 330 reports 726 rewards account balances. Account balances can be printed on transaction receipts or reported in conjunction with confirmation codes for online transactions. After this, the routine 700 ends 728. In other embodiments, the routine 700 can end 728 following steps 708, 710, 712.

Rewards accounts can be configured with a revolving point balance in which points deposited in the rewards account do not expire. In other embodiments, the points earned can expire following term periods according to the conditions stipulated by the merchant loyalty rewards program and defined by point earning rules.

In another embodiment of an implemented loyalty program, a merchant redeems a coupon presented 714 by a consumer in association with a transaction. The coupon can be identified by the coupon serial number and linked to the customer's reward account. Redemption can consist of debiting 722 an indicated number of points from the rewards account and giving the consumer the value described in the coupon message. In a further embodiment, redemption of coupons may not result in depleting points from a rewards account but may be offered as an additional loyalty incentive. Further embodiments of the present invention can allow merchants to define offers through an OFFERS function of the customer loyalty module 330. Offers can be similar to coupons; however, they may not be individually issued to customers and may not bear a serial number. An offer can have a name, a consumer-visible description, an offer redemption amount, and a valid date range. Redemption of the offer can result in debiting 722 and indicated number of points from the rewards account, after which the merchant may give the customer the value described in the offer. In other embodiments, redemption of offers may not result in depleting points from a rewards account but may be offered as an additional loyalty incentive.

Consumers and merchants can receive many benefits from the merchant loyalty and rewards programs described in detail above. Consumers receive greater value through purchasing loyalty and they receive this benefit at the POS through a transparent rewards account setup with no explicit registration process. Additionally consumers are able to earn and use their rewards points in a fluid manner through use of their preferred payment instrument (e.g. credit or debit card) without the requirement to carry additional cards, or other access instruments. Consumers may also be able to receive rewards account statements and/or coupons at the time of sale or through online tracking facilitated by the consumer self-service module 332.

Merchants benefit from a quick to market, easy to implement reward program that will enhance retention and boost profitability. Through implementation of the customer loyalty module 330, merchants can provide motivation for their customers to purchase additional products that may have a better overall profit margin. For example, a quick service restaurant might reward a regular customer with a coupon to try its higher margin premium coffee for free. The present invention can also provide multiple reward approaches with varying parameters that can be tested and implemented. Parameters can be set to best suite any particular merchant managing a variety of business models. For example, parameters may include frequency of purchase, time of purchase (e.g. day, week), category of purchase (new category of purchase for a particular customer, category profit margins, etc.), and other purchase behavior parameters. Merchants can be given the flexibility to design the rewards program that best suits their needs and customer behaviors.

Other payment system participants, such as acquiring banks, can also benefit from the merchant loyalty program aspects of the present invention. For example, acquiring banks and payment processors are able to offer a sophisticated rewards capability to their merchant clients and subsequently enjoy greater merchant influence by being able to provide a full payments suite including a customer rewards module 330 without introducing third parties and associated integration efforts or revenue sharing. Acquirers can offer a rewards solution with little incremental expense, and in turn can obtain incremental revenue through account maintenance fees and transaction fees for rewards account transactions. This integrated value can balance with and compensate for ongoing requests from merchants for lower transaction processing fees.

D. Embodiments of Systems for Managing Merchant-Specific Transaction Accounts Associated with an Instrument

1. Secure Payment Profile Management

Merchants process cardholder data in order to collect revenue from payment card transactions, but that “critical” cardholder data may be subject to threats that can potentially damage the merchant's business. Theft, misuse, and accidental disclosure of cardholder data can lead to lost transactions, charge-backs, substantial fines, lost customers, the loss of a merchant's ability to accept credit cards, as well as legal consequences for the merchant's business.

Referring back to FIG. 3, merchants need access to cardholder data for most of the business processes surrounding credit and debit card transactions, including interactive transactions at the POS station 304, through the Internet, and in a telephone order environment. Additionally, transactions with stored account payment credentials, transactions that establish a stored value account, transactions that sign up a new member to a subscription service, and transactions initiated as recurring billing of an existing service member also require access to cardholder data. Merchants also frequently require access to critical cardholder data for customer support purposes including post-sales customer support that involves crediting customer purchases, transaction charge-back processing, fraud analysis, and managing exceptions in recurring billing accounts.

In order to minimize the window over which critical data must be stored, the transaction server 302 can define the core purchase API commands (e.g. AUTH, CAPT, SALE, CRED, VOID) so that the requirements for critical data are minimized. The AUTH and SALE API commands are the only API commands that require critical data, such as track data, account numbers, and CVV codes. The other API commands, such as CAPT, CRED, and VOID, do not require critical data to be re-represented. Critical data is retained on the transaction server 302 and supplied implicitly by referencing the AUTH and SALE commands; therefore, critical data does not have to be stored by the merchant or at the POS station 304.

The transaction server 302 API commands allow the merchant to architect their cardholder data processing so that card numbers are not persisted, thereby preventing risk of lost or stolen card numbers. In one embodiment, merchant business processes such as a customer-present, real-time, AUTH can be implemented without persisting critical data. For example, data may be gathered from the consumer by merchant software. The merchant software does not need to store the critical data, but can simply send the critical data in an AUTH command to the transaction server 302. If a real-time AUTH command completes, the critical data is no longer required and can be erased from volatile storage. In the rare instance where a real-time AUTH command must be reattempted, the customer may be required to re-swipe or re-input only the critical data associated with the card.

Processing off-line AUTH commands does require persisting all AUTH data, including critical data, until the AUTH command can be presented to the transaction server 302. In this instance, the merchant must employ extra security measures to protect the critical data that is saved for off-line authorization.

In an embodiment, the transaction server 302 has a payment profile creation API command called PAYASYOUGO, which stores critical cardholder data within the transaction server 302 and returns a unique account ID (ACCTID command) to reference that profile. THE PAYASYOUGO ACCTID can be used in all instances where cardholder account numbers are used. Since the PAYASYOUGO ACCTID is not critical cardholder data, the security concerns related to this token are more relaxed. PREPAY and SUBSCRIBE API commands can similarly store critical data upon account activation, obviating later use. In one embodiment, these account types can be opened with the PAYASYOUGO ACCTID.

Beneficially, the transaction server supported API commands remove the requirement for keeping merchant-side critical data, regardless of the combination of business models being used. Most customer support processes do not require viewing critical data; rather, the processes require the ability to work with that data. For example, critical data is not required to credit a prior sale, to update expired card information or profile data, or to change a card number on file. Customer support facilities in the payment processing system 300 allow the customer support representative to work with cardholder data without ever revealing that cardholder data. In some instances, a customer support process requires matching a transaction to a given card. The transaction server 302 implements this match through the PAYASYOUGO ACCTID. Internally, the transaction server 302 implements card matching using a one-way has of the card, which minimizes the requirements for storing critical data.

2. Transaction Processing at the Point-of-Sale

In one embodiment, the transaction server 302 processes transactions from merchants operating a traditional POS station 304, as well as from online, mobile, and unattended POS stations. The transaction server 302 processes PAYASYOUGO payment commands, therefore it is straightforward to integrate standard POS equipment such as payment terminals, electronic cash registers, and store management systems by configuring them to send standard AUTH, CAPT, SALE, CRED, and VOID commands to the transaction server 302. The commands can be automatically optimized through the account management module 326 which is configured to access the linked accounts in a preferred order and facilitate efficient transaction processing regardless of the type of transaction (e.g. pay-per-use, virtual prepaid, virtual subscription, rewards, or post-paid).

All or most account types can be used at the POS, while maintaining traditional POS workflow. For example, the accounts can be opened/activated and linked to an instrument/card simply by selecting the particular purchase plan and swiping or otherwise entering the consumer's card information. The merchant may prioritize the plans available for her customers such that the merchant's preferred payment account may be accessed and used for payment transactions. For example, if a consumer has a virtual prepaid account tied to his account, the virtual prepaid account balance will be debited for a transaction in preference to using the pay-as-you-go account. Beneficially, the transaction server 302 resolves the purchase to a particular account through the account management module 326, so that the POS device does not need to know in advance which account will be charged for a particular transaction. In other embodiments, the consumer may explicitly specify the account to be charged.

Account status, such as the balance of a consumer's virtual prepaid account, may be returned in the transaction response message. Data from this message may be printed on the consumer's receipt so that, for example, account balances, rewards points earned, rewards points balances, and coupons may be given to the consumer. Merchants may also define virtual prepaid plans with automatic top-up provisions, and once established such accounts can be sued by the consumer without having to set them up gain.

The payment processing system 300 speeds transaction flow as well as allows for off-line authorization for transactions. Beneficially, the transaction server 302 “single swipe” behavior speeds purchasing for consumers and merchants while providing a platform by which a merchant can encourage consumers to repeat-purchase.

3. Real-Time Processing of Virtual Prepaid, Virtual Subscription, and Rewards Accounts

Some payment processing applications require transaction processing with “hard” real-time response times. Mass transit systems, for example, must make the decision to open or close the fare gate in under 300 milli-seconds. Current credit and debit card networks cannot meet this real-time requirement, because network processing delays are both too slow and too unpredictable. These networks typically respond in 500 to 2,000 milli-seconds with delays that can extend to 30,000 milli-seconds.

The real-time processing requirement is one of two major reasons for the existence of special-purpose transit cards based on card-resident “smart card” processing. The other major reason is that, at $1.75 in the U.S. for example, the average mass transit fare is a micro-payment, and micro-payment solutions using general purpose payment cards have not been readily available.

The functionality of the transaction server 302 offers sophisticated and flexible small-payment solutions that addresses both the micro-payment and real-time processing requirements of transit systems. With implementation of the transaction server 302, transit systems may accept general-purpose credit and debit cards at the fare gate, and consumers do not have to be issued special-purpose cards.

The transaction server 302 can process the transit single-journey transactions using intelligent aggregation technology, which increases the profitability for small and micro-transactions for the transit agency. Intelligent aggregation technology is more fully described in U.S. patent application Ser. No. 11/169,075, entitled “PAYMENT PROCESSING METHOD AND SYSTEM,” which is incorporated herein in its entirety by reference. Transit agencies have complex fare programs, and the transaction server 302 supports the creation of a “Virtual Transit Card” linked to a general-purpose credit or debit card, implemented on virtual prepaid and virtual subscription account support. For example, virtual subscription accounts implement time-based passes which, for transit systems, are often for periods of time like a day, a week, or a month. Virtual prepaid accounts implement multi-trip passes. Incentives may be given to implement these types of accounts. An example of this embodiment may be a transit card program that gives $12 in rides for every $10 purchase.

Edge-based architecture for processing virtual prepaid, virtual subscription and post-authorized pay-as-you-go transactions (described in detail in U.S. patent application Ser. No. 11/169,075) can process transactions in less than 100 milli-seconds, leaving 200 milli-seconds for other processing requirements at the fare gate. This transaction speed allows for scalable, reliable, and secure server-based processing that meets the real-time response requirements of transit systems while allowing consumers access to these services through their preferred credit or debit card.

The transaction server 302 can achieve high speed processing when virtual prepaid and virtual subscription processing is handled on a distributed and partitioned set of Edge processors. Depending on the peak load requirements, the number of Edge processors can be expanded to offer reliable response times under 100 milli-seconds. Statistical modeling of the load may be used to ensure that the transaction server-based solution meets the response-time requirements with reliability exceeding 99%.

For transit system applications, pay-as-you-go transactions may be processed in a post-authorized manner, in one embodiment. A post-authorized request returns with an immediate successful micro-authorization while initiating a macro-authorization that returns asynchronously. If the macro-authorization succeeds, then the successful micro-authorization was the proper result. If the macro-authorization fails, then the micro-authorization is marked as filed and future micro-authorizations associated with the denied instrument can be denied (if that is the desired merchant policy).

4. Transaction Servers for Acquiring Banks and Processors

The largest payment processors serve millions of merchants, with integration into millions of POS systems and hundreds of thousands of eCommerce systems. A large fraction of these merchants have businesses which would benefit from the functionality of the transaction server 302. The transaction server 302 may be integrated with the large-scale processors of acquiring banks and processors enabling very-large scale rollouts of the technology of the present invention to hundreds of thousands of merchants.

The transaction server 302 can support the immediate large-scale deployment of a small payment “mode” with intelligent aggregation, virtual prepaid, virtual subscription and rewards accounts as well as customer self-service to an integrated processor's entire merchant customer base. The transaction server 302 enables the extension of the processors current credit and debit card processing API commands to a variety of account types.

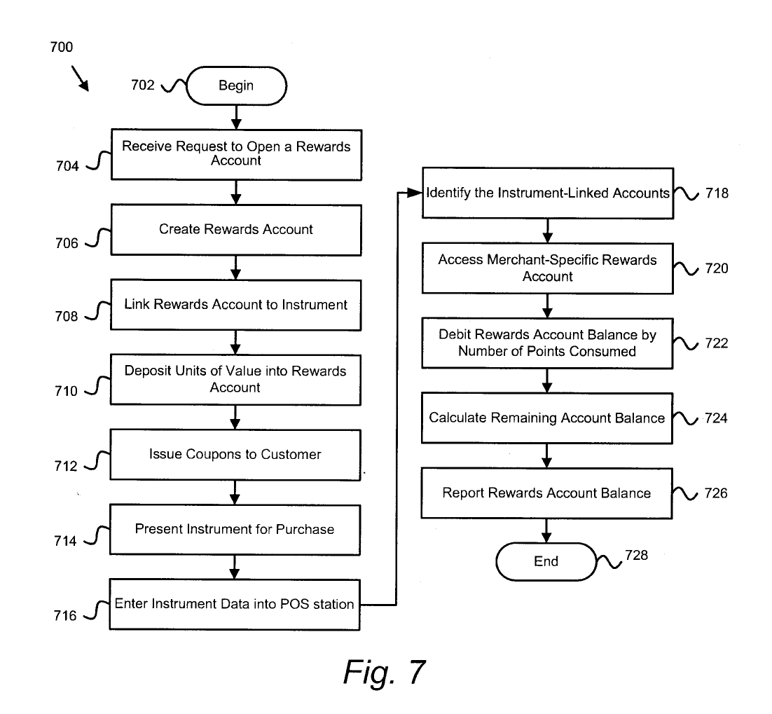

As illustrated in FIGS. 8A and 8B, a transaction server 802 can be installed on the premises of large-scale processors 804 enabling near-seamless integration into the existing business processes of the large-scale processors 804. The transaction server 802 can support existing processes for adding partners (Acquirers, ISOs, and Agents) and allows each partner to shape and control the payment processing products deployed by their merchants. The transaction server 802 can support the processor billing process 808, so that the processor 804 and the processor's partners can operate a payment processing business successfully. Additionally, the transaction server 802 can incorporate a consumer self-service module 332 with functionality that can be packaged with the processor's other consumer-facing portal offerings.

The transactions server 802 supports the ability for processors to add virtual prepaid, virtual subscription, and rewards capabilities as loyalty-based payment programs for merchants 806. To enable fast rollout, the transaction server 802 may provide a virtual prepaid, virtual subscription, and rewards payment terminal application that can be added on to existing processor payment terminal applications 810.

Beneficially, consumers may be provided with an extended number of points of purchase locations that accept payment cards as access to virtual prepaid, virtual subscription, and merchant rewards accounts. For each of these merchant-specific accounts, consumers may get an integrated statement with merchant-specific, online self-care that enables consumers to receive accumulated transaction details, account balance summaries, and mechanisms for transaction dispute resolution. Merchants may receive the full benefit of the transactions server capabilities when they implement the service from their acquiring bank or processor. Advantages to merchants include, but are not limited to, lower cost and faster implementation of loyalty-based payment plans and rewards accounts linked to their customer's preferred payment instrument. Acquiring banks and processors are able to provide these services to their merchant clients without introducing third parties or revenue sharing. Additionally, acquirers may offer a virtual payment plan and rewards solution with little incremental expense, and in turn may obtain incremental revenue through account maintenance fees and transaction fees for account transactions. This integrated value may balance with and compensate for ongoing requests from merchants for lower transaction processing fees.

5. Transaction Servers for Issuing Banks

Issuing banks are in a constant search for strategies to achieve “top of wallet” status with cardholders. The marketplace has seen an explosive growth in prepaid, gift, affinity and contact-less offerings from both merchants and issuing banks, but a large number of these initiatives fail to meet expectations.

Compounding the challenges Issuers face in capturing market share and growing revenues, the market for new cards in the United States is approaching saturation. New markets must therefore be opened to drive revenue growth. The small payment and customer loyalty spaces are exciting in their volume, relative early stage of development, and richness of specific opportunities available to an Issuer to capture early mover advantages.

The size of the untapped cash-to-credit small payment market is enormous. Industry analysts estimate that in 2004, $1.3 trillion was spent on small cash purchases at under $5 per transaction. Another factor to consider is that with more incentives from merchants for small ticket purchases, cardholders will increase the frequency of use of merchant-preferred cards. It seems likely that this change in behavior will have the side-effect of a significant increase in charge volume for larger “standard” ticket transactions on the same card.

Issuer's business processes, particularly those related to customer service and the resolution of merchant billing disputes, are geared to transactions of relatively large size. Therefore, issuers report that they lose money on small transactions, with issuer customer service costs and transaction processing costs making up the majority of the costs. In the United States, the policies and procedures for issuer customer care are woven into Federal law which regulates credit card transactions (Regulation Z) and debit card transactions (Regulation E), so it is difficult to redefine the customer care rules for credit and debit cards in order to relieve some of the cost pressure on small transactions. Additionally, the issuer-internal costs of dispute resolution are high enough that some issuers reportedly will forgive the cost of disputed small transactions and give the consumer a refund without raising the dispute with the acquirer or merchant. This approach is tenable only if small transactions are rare, and will not be tenable as the use of credit and debit cards for small transactions grows.

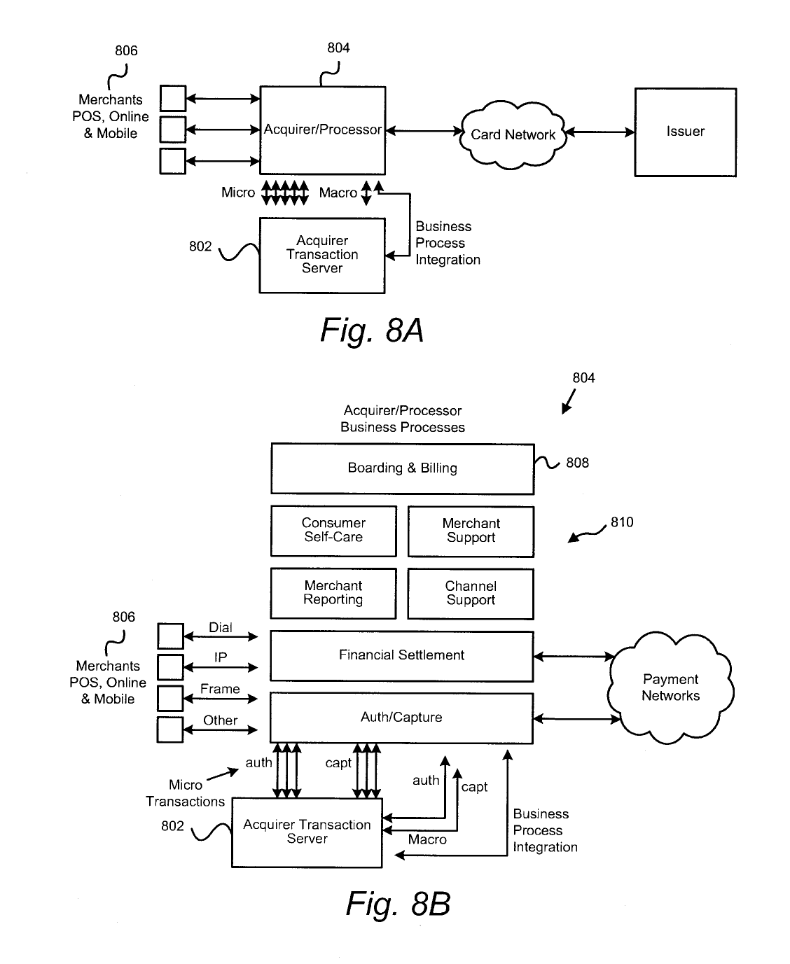

As illustrated in FIG. 9, a transaction server 902 may be implemented for issuers. The transaction server 902 consists of three integrated components: issuer Intelligent Aggregation, issuer small payment plan rewards, and issuer consumer self-care. The transaction server 902 may be installed on the premises of issuer processors 904 enabling near-seamless integration into the issuing bank's existing business processes and may provide additional benefits for current issuer credit and debit cards. Certain provisions of the transaction server 902 require consumer acceptance, which would be gathered from the issuer as part of the rollout of a comprehensive, issuer-specific, offering to consumers.

Issuer intelligent aggregation systems can aggregate small ticket spending into a single line item presented to the consumer on their credit or debit card statement. Optionally, the issuer 904 can show merchant-specific charges on the printed statement. The issuer transaction server 902 can provide for the creation of a cross-merchant or “universal” virtual prepaid account. This consumer elected feature authorizes, captures, and settles transactions out of the universal virtual prepaid account. For example, as transactions occur and the universal virtual prepaid account is debited, an automatic top-up feature may deposit funds in the universal virtual prepaid account from the primary credit or debit account. Maintenance of the account can be synchronized with the consumer billing cycle in order that the prepaid balance is kept at an agreed-upon amount. In one embodiment, the issuer transaction server 902 may manage the universal virtual prepaid account in a manner that maintains the balance at zero at the end of the billing period so that the consumer's prepaid commitment is minimized. In another embodiment, the issuer transaction server 902 can maintain the prepaid balance at a higher amount. In this embodiment, the issuer's cost may be lowered and the issuer 904 may offer the consumer an incentive to choose this option.

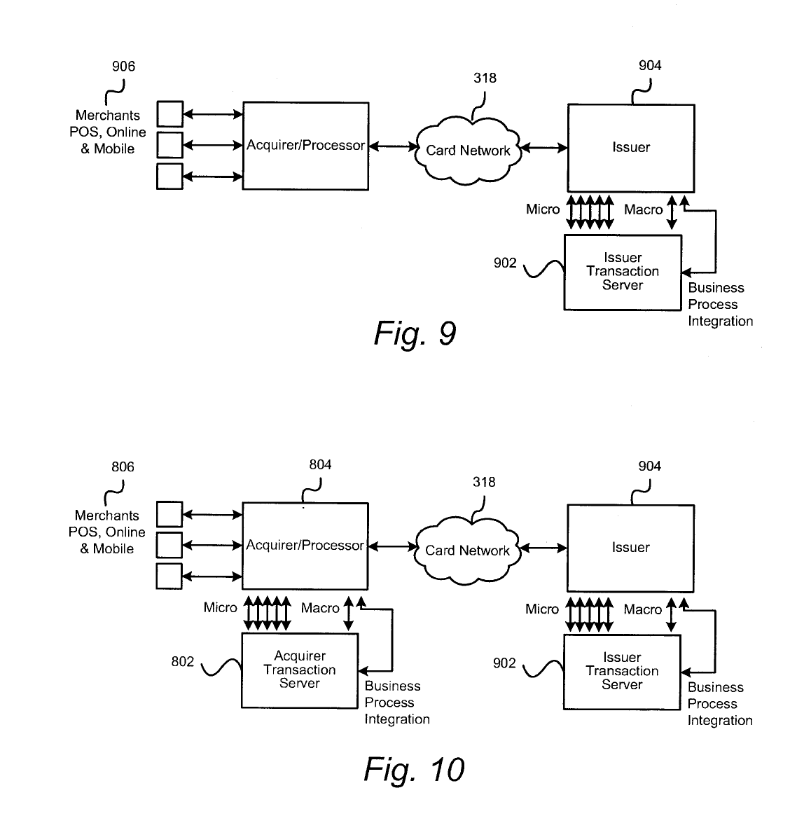

The transaction server 902 can be configured to process all transactions at the issuing bank 904, including transactions that originate from merchants 906 that are not using transaction server capabilities and those merchants 806 that are. As illustrated in FIG. 10, if both the issuing bank 904 and the merchant associated acquiring bank 804 operate transaction servers 802, 902, that can interact via the card payment network 318. For example, in transaction instances where the merchant's acquiring bank or processor 804 is also using the transaction server 802, the issuing transaction server 902 can respond to a new transaction AUTH command in a manner that optimizes the timeliness of cash flow to the merchant 806 and interchange cost to the merchant 806, while maintaining the authorization's guarantees of payment to the merchant. If only the issuing bank 904 is operating the transactions server capabilities, no new interactions are required between the issuer 904 and card payment network 318.

The issuer small payment plan rewards component enables issuers 904 to encourage the consumer to use the issuer's card for transactions using reward mechanisms. The small payment rewards system implements an extension to issuer's existing rewards programs, lowering the cost of implementation of rewards programs for small transactions and additional account types that are linked to the primary account. The issuer small payment rewards system can be integrated with merchant rewards programs to increase the incentives for a cardholder to use the card at the merchant. The platform enables the implementation of flexible and powerful integrated merchant and issuer programs. For example, incentives, in one embodiment, can be given from the issuer 904 to the merchant 806, 906 through a reduction in merchant interchange fees in return for an increased reward by the merchant 806, 906 to the consumer. In another embodiment, incentives can be given from the issuer 904 directly to the consumer at a specific merchant 806, 906, offering the consumer a price break for a specific purchase, or related reward offering. In a further embodiment, incentives can be given from the merchant 806, 906 to the issuer, for example through an increase in merchant interchange fees in return for an increased reward to the consumer by the issuer 904. Those of ordinary skill in the art will recognize other rewards and incentives.

The issuer consumer self-care component can provide an interface for efficient and effective consumer self-care. Consumer self-care can be provided by the consumer self-service module 332. Automated online consumer self-service, integrated with issuer systems, decreases customer service costs by enabling customer self-care and dispute resolution. Likewise, consumer self-service increases customer satisfaction by providing valued information regarding their purchases and providing an automated and mediated avenue for disputes. Using an online system, consumers can have access to the details of their transactions within the small payment line item. Details can show the small transactions made with all merchants and from all account types. If both the issuing bank 904 and the merchant associated acquiring bank 804 operate transaction servers 802, 902, the customers can be provided with an integrated customer care system providing a central point for viewing and managing issuer customized account offerings and transactions as well as merchant product offerings and account balances for all linked accounts, including merchant rewards accounts.

In one embodiment, consumers may initiate disputes if they have a reason to dispute a transaction. Within issuer transaction servers 902, these disputes can be handled by either the existing chargeback workflows, or if a merchant 806 or acquirer 804 deploys transaction servers 802, then the disputes can be handled through automated systems at lower cost to issuer 904 and merchant 806. In some embodiments, consumers that have a history of undue disputes can have their disputed transactions flagged for investigation and review.

It will be appreciated by one of ordinary skill in the art that data generated through the use of the transaction server 302 in the payment processing system 300 can be organized, packaged, distributed, sold, etc., for purposes of increasing the transaction volume of businesses, starting new businesses, consumer marketing, implementing loyalty programs, and the like. Data generated through use of the system 300 can include, but is not limited to, consumer purchase behavior, loyalty program usage, merchant sales data, instrument and account-type preferences, etc. Additionally, it will be appreciated that the data can be collected from several communication points in the system 300 (e.g., POS stations 304, online consumer self-service websites, the card payment network 318, financial service institutions 320, etc.).

In general, the detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or steps are presented in a given order, alternative embodiments may perform routines having steps, or employ systems having steps, in a different order, and some processes or steps may be deleted, moved, added, subdivided, combined, and/or modified. Each of these processes or steps may be implemented in a variety of different ways. Also, while processes or steps are at times shown as being performed in series, these processes or steps may instead be performed in parallel, or may be performed at different times.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the invention reside on a server computer, while corresponding portions reside on a client computer such as a mobile or portable device, and thus, while certain hardware platforms are described herein, aspects of the invention are equally applicable to nodes on a network.

The teachings of the invention provided herein can be applied to other systems, not necessarily the system described herein. The elements and acts of the various embodiments described herein can be combined to provide further embodiments.

Any patents, applications and other references, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description details certain embodiments of the invention and describes the best mode contemplated, no matter how detailed the above appears in text, the invention can be practiced in many ways. Details of the invention may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the invention.

1. A system for use by a financial service institution to provide an account linked to a consumer payment instrument, the system comprising:
a computer network for transmitting payment processing commands;
a point-of-sale station associated with a merchant and in communication with the computer network, wherein the point-of-sale station is configured to receive information from the payment instrument;
a transaction server associated with the financial service institution and in communication with the computer network, wherein the transaction server is configured to create the account, deposit value in the account, and to receive payment processing commands from the point-of-sale station;
wherein the account is linked to the payment instrument; and
wherein the information from the payment instrument provides access to the account.

2. The system of claim 1 wherein the payment instrument is at least one of a general purpose credit card and a debit card.

3. The system of claim 1 wherein the account includes a merchant-specific account.

4. The system of claim 1 wherein the transaction server manages an account balance associated with the merchant-specific account.

5. The system of claim 1 wherein the transaction server is further configured to debit the account during a payment transaction.

6. The system of claim 1 wherein the account includes a virtual prepaid account, and wherein the transaction server receives funds from the consumer to increase a balance in the virtual prepaid account.

7. The system of claim 1 wherein the account includes a virtual subscription account, and wherein the transaction server receives funds from the consumer to activate the virtual subscription account.

8. The system of claim 1 wherein the account includes a rewards account, and wherein the transaction server is configured to deposit reward currency in the rewards account when the consumer completes a qualifying purchase at the point-of-sale terminal.

9. The system of claim 1 wherein the point-of sale station includes a website.

10. The system of claim 1 wherein the point-of sale station includes a card reader at a check-out stand.

11. The system of claim 1 wherein the point-of sale station includes a mobile device.

12. The system of claim 1 wherein the payment instrument includes a general purpose credit card.

13. The system of claim 1 wherein the payment instrument includes a debit card.

14. The system of claim 1 wherein the payment instrument includes a RFID-based instrument.

15. The system of claim 1 wherein the payment instrument includes a website account identifier.

16. The system of claim 1 wherein the transaction server is configured to access more than one account during a payment transaction

17. In a payment processing system, a computer-implemented method for performing a transaction with a consumer's payment instrument linked to a first account, the method comprising:
receiving a request to open a merchant-specific second account;
in response to the request, creating a merchant-specific second account;
linking the merchant-specific second account to the payment instrument;
depositing value in the linked merchant-specific second account to increase an account balance at a first transaction time; and
at a second transaction time, after the first transaction time, accessing the linked merchant-specific second account with the payment instrument.

18. The method of claim 17, further comprising decrementing an account balance by an amount corresponding to a purchase transaction amount.

19. The method of claim 18, further comprising calculating a remaining account balance following decrementing the account balance.

20. The method of claim 17, further comprising reporting an account balance to the consumer.

21-36. (canceled)
